(19) United States
(12) Patent Application Publication
(10) Pub. No.: US 2015/0371031 A1
(43) Pub. Date: Dec. 24, 2015

(54) METHOD, SYSTEM, AND AUTHENTICATION DEVICE

(71) Applicant: FUJITSU LIMITED, Kawasaki-shi (JP)

(72) Inventors: Masaru UENO, Kawasaki (JP); Kouichirou Amemiya, Kawasaki (JP)

(73) Assignee: FUJITSU LIMITED, Kawasaki-shi (JP)

(21) Appl. No.: 14/696,769

(22) Filed: Apr. 27, 2015

(30) Foreign Application Priority Data
Jun. 23, 2014 (JP) 2014-128660

(51) Int. Cl. G06F 21/45; G06F 21/31; G06F 21/30

(52) U.S. Cl. CPC G06F 21/45; G06F 21/30; G06F 21/31

(57) ABSTRACT

A method includes: receiving a request for processing, the processing having to be preceded by an authorization process for a source of the request, the authorization process being performed based on authorization information which a term of validity is set; storing historical information indicative of a history of a request for the processing from the source; and setting, by a processor, the term of validity of the authorization information based on the historical information.

### CROSS-REFERENCE TO RELATED APPLICATION

This application is based upon and claims the benefit of priority of the prior Japanese Patent Application No. 2014-128660, filed on Jun. 23, 2014, the entire contents of which are incorporated herein by reference.

### FIELD

The embodiment discussed herein is related to a method, a system, and an authentication device.

### BACKGROUND

Virtualization infrastructures are known in which a plurality of physical resources for processing information are virtualized. Virtual resources in a predetermined unit are assigned from a virtualization infrastructure to the user of the virtualization infrastructure. This assignment allows the user to construct a virtual system and use the virtual infrastructure. However, before virtual resources are assigned to the user, an authorization process for determining whether or not to authorize the user to use the virtualization infrastructure is performed. When the authorization process succeeds, the user may receive an assignment of virtual resources. Note that authorization information used for the authorization process has a definite term of validity in order to maintain the security strength.

A technique for causing the duration of validity of a temporary password issued by an authentication service provider to be different for every service user identifier is known. A technique for setting the duration of validity of a one-time password in consideration of a time period taken for a financial transaction is also known. A proxy service that vicariously performs authentication using a security token is also known.

International Publication Pamphlet No. WO 2006/068998, Japanese Laid-open Patent Publication No. 2007-226763, and Japanese Laid-open Patent Publication No. 2005-062556 are known examples of the related art techniques.

### SUMMARY

According to an aspect of the invention, a method includes: receiving a request for processing, the processing having to be preceded by an authorization process for a source of the request, the authorization process being performed based on authorization information which a term of validity is set; storing historical information indicative of a history of a request for the processing from the source; and setting, by a processor, the term of validity of the authorization information based on the historical information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a physical configuration of a system of an embodiment;

FIG. 2 illustrates an example when part of physical configuration is virtualized in the system of the embodiment;

FIG. 3 illustrates an example of a login authentication process and token authorization processes at the time of using a virtualization infrastructure of the embodiment;

FIGS. 4A, 4B, and 4C illustrate examples of ways in which users use the virtualization infrastructure of the embodiment;

FIG. 5 illustrates an example of functional blocks of an authentication device of the embodiment;

FIG. 6 illustrates an example of a login authentication process performed by the authentication device of the embodiment;

FIG. 7 depicts an example of a token that is authorization information having a term of validity of the embodiment;

FIG. 8 illustrates an example of a process performed by an acceptance device of the embodiment;

FIG. 9 depicts an example of information for a token authorization process of which the authentication device of the embodiment is notified;

FIG. 10 illustrates an example of a process performed by a management device of the embodiment that manages virtual resources;

FIG. 11 illustrates an example of a token authorization process performed by the authentication device of the embodiment;

FIG. 12 depicts an example of a log stored by the authentication device of the embodiment;

FIG. 13 illustrates an example of an update rule creation process performed by the authentication device of the embodiment;

FIG. 14 depicts an example of a determination criterion referred to when an update rule of the embodiment is created;

FIG. 15 depicts an example of an update rule for updating an expiration date of the authorization information having a term of validity of the embodiment;

FIG. 16 illustrates an example of a process of deleting a token, which is authorization information having a term of validity, performed by the authentication device of the embodiment; and

FIG. 17 illustrates an example of a hardware configuration of each device of the embodiment.

### DESCRIPTION OF EMBODIMENT

In a virtual system constructed using a virtualization infrastructure, the configuration and specifications may be easily changed owing to the advantage of using virtual resources. For this reason, the user of a virtualization infrastructure may, for example, not only provide services using a virtual system, but also evaluate a plurality of systems while repeatedly changing the configuration and specifications of the virtual system.

However, changing the configuration and specifications of a virtual system involves changing usage details of virtual resources in the virtualization infrastructure. Before changing the configuration and specifications, an authorization process is therefore performed for determining whether or not to authorize the user to use the virtualization infrastructure.

Authorization information used for the authorization process has a term of validity for maintaining the security strength. For example, authorization information is registered in a database and is deleted from the database after the term of validity has expired.

Supposing that a plan for changing the configuration and specifications of a virtual system is known, the term of validity of the authorization information may be set longer so that the term of validity has not expired until the completion of changing the configuration and specifications. As a result, the authorization information is unlikely to be deleted from the database. This removes the necessity to reacquire the authorization information, and therefore the convenience of the authorization information may be increased.

However, if the term of validity of authorization information is set too long, the authorization information will be continuously registered in a database even during a period when no authorization process occurs. The risk that the authorization information will be acquired by a malicious user would therefore be increased. Additionally, the term of validity being set too long makes it unlikely that the authorization information will be deleted from the database. When an authorization process is performed for another user, an increased amount of authorization information in the database would therefore have to be collated.

On the other hand, if the term of validity of authorization information is set rather short, a user who changes the configuration and specifications of a virtual system relatively frequently has to acquire authorization information again because the term of validity of the existing authorization information has expired at the time of changing. This would decrease convenience of authorization information.

As such, the term of validity of authorization information used for an authorization process for a user has a trade-off relationship between the convenience and the security strength, as well as the load of the authorization process.

An object of the present application is to provide authorization information that is easy to use.

According to one aspect of the present disclosure, the expiration date of authorization information having a term of validity used for an authorization process for a user is updated in accordance with the situation in which the authorization process for the user concerned occurs.

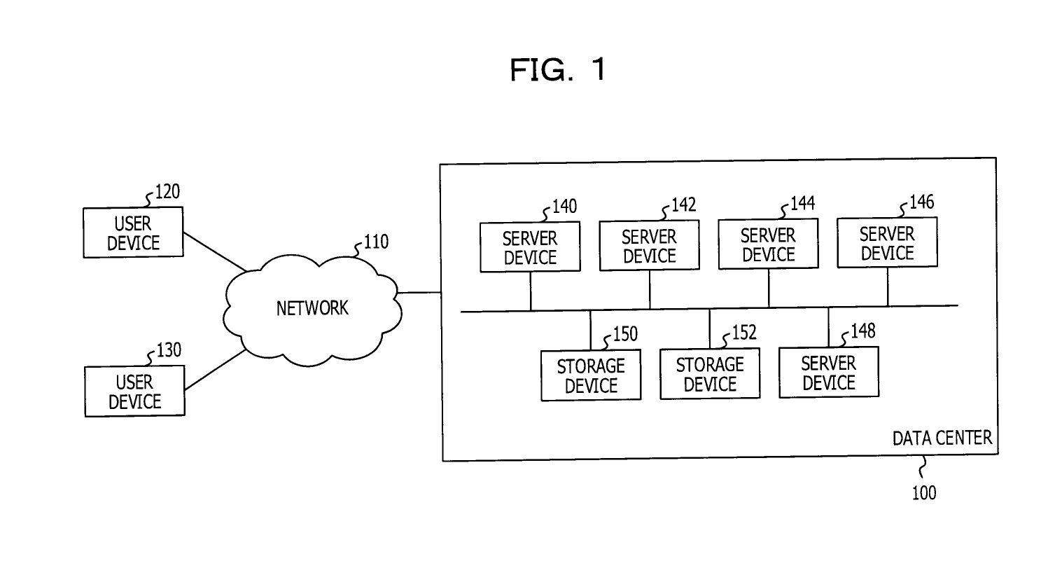

FIG. 1 illustrates an example of a physical configuration of a system of an embodiment. In FIG. 1, a data center 100, and a user device 120 and a user device 130 each coupled via a network 110 to the data center 100 are illustrated. The data center 100 includes a server device 140, a server device 142, a server device 144, a server device 146, a server device 148, a storage device 150, and a storage device 152. The server device 140, the server device 142, the server device 144, the server device 146, the server device 148, the storage device 150, and the storage device 152 are mutually coupled via a communication line. Note that the embodiment is not limited to the number of devices or the like illustrated in the drawing.

The user device 120 requests, via the network 110, one or more server devices among the server device 140, the server device 142, the server device 144, the server device 146, and the server device 148 included within the data center 100 to perform specific processing. The server device requested for the specific processing performs the requested specific processing and sends the result of the specific processing via the network 110 to the user device 120.

Note that, as described below, a plurality of physical resources included in the data center 100 are virtualized. The user device 120 and the user device 130 access the data center 100 and construct a virtual system using virtualized physical resources. One user provides a service utilizing the virtual system. Another user artificially constructs a specific system in the form of a virtual system and evaluates the specific system using the virtual system.

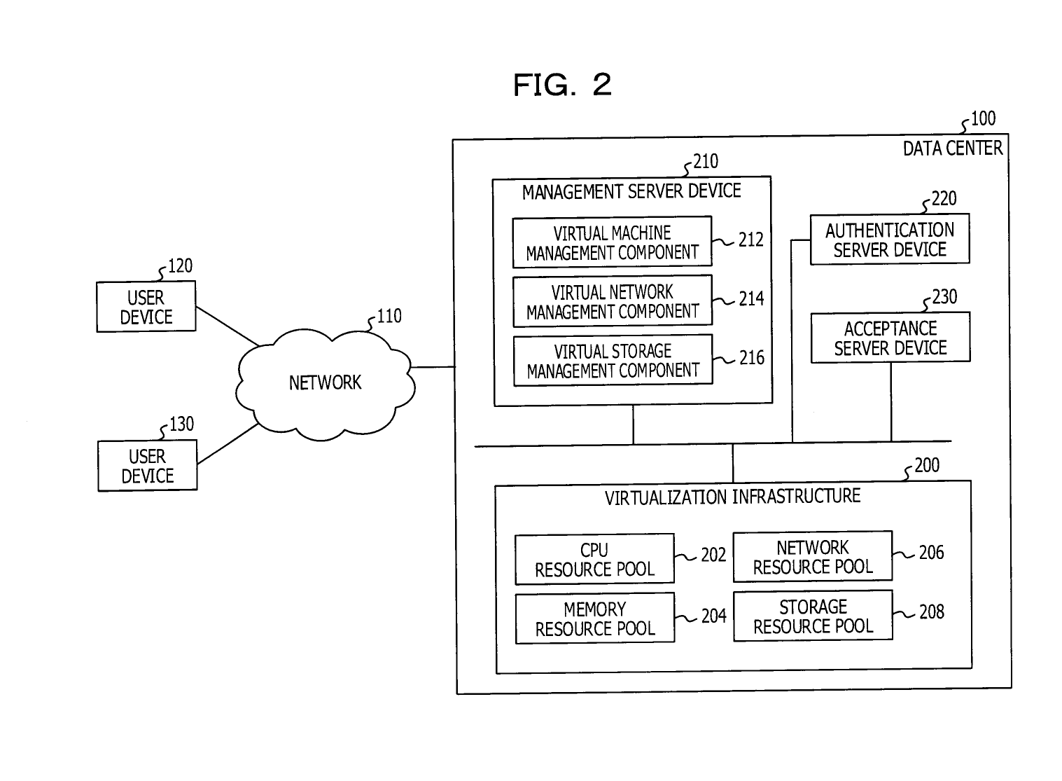

FIG. 2 illustrates an example when part of a physical configuration is virtualized in the system of the embodiment. FIG. 2 illustrates a virtualization infrastructure 200 of a plurality of physical resources included within the data center 100 illustrated in FIG. 1. In the virtualization infrastructure 200, physical resources included in the server device 146, the server device 148, the storage device 150, and the storage device 152 are collected for each kind of resource and thus are managed as the a central processing unit (CPU) resource pool 202, a memory resource pool 204, a network resource pool 206, and a storage resource pool 208. Note that the embodiment is not limited to the number of devices or the like illustrated in the drawing.

A management server device 210 manages these resource pools. The management server device 210 is, for example, implemented when a particular program is loaded into memory included in the server device 140 illustrated in FIG. 1 and the particular program is executed by a CPU of the server device 140. In addition, when the particular program is executed by the CPU of the server device 140, a virtual machine management component 212, a virtual network management component 214, and a virtual storage management component 216 are implemented in the management server device 210.

The virtual machine management component 212, the virtual network management component 214, and the virtual storage management component 216 have functions of managing a plurality of physical resources within the data center 100 so that the plurality of physical resources may be used as virtual resources in a predetermined unit. These management components accept a request from a user of the virtualization infrastructure 200 and assign virtual resources in the predetermined unit from the plurality of physical resources to the user in response to the request. These management components manage virtual resources so as to avoid a conflict among a plurality of users for use of virtual resources.

Note that virtual resources are collected in accordance with their kind and, as a result, are managed as the CPU resource pool 202, the memory resource pool 204, the network resource pool 206, and the storage resource pool 208 described above. The virtual machine management component 212 manages the CPU resource pool 202 and the memory resource pool 204, the virtual network management component 214 manages the network resource pool 206, and the virtual storage management component 216 manages the storage resource pool 208.

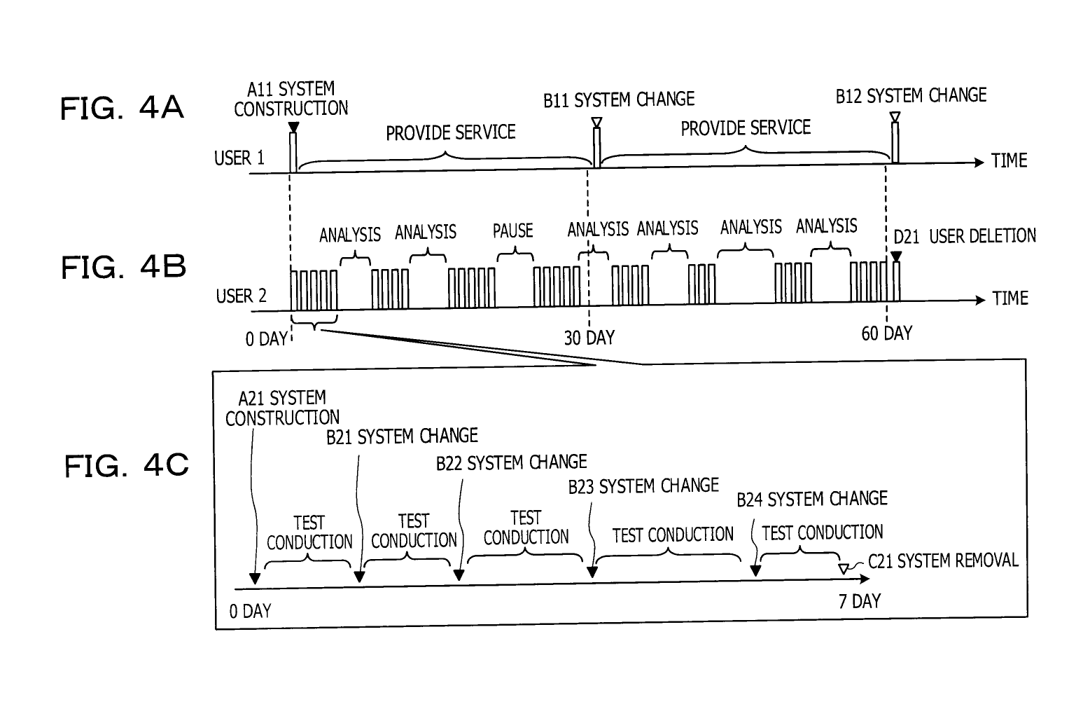

The user who is assigned virtual resources in the predetermined unit from the plurality of physical resources by the management components constructs a virtual system using the virtual resources. Although the usage ways of a virtual system will be described in conjunction with FIG. 4A, FIG. 4B, and FIG. 4C, operations performed by the user when constructing a virtual system are now described.

First, the user registers their user account in order to use the virtualization infrastructure 200. Through this account registration, the user acquires a user identifier (ID) and a password associated with the user ID.

Then, the user performs system construction of a virtual system. In this system construction, tenant creation, virtual network creation, virtual machine creation, and so forth are performed based on a configuration file in which usage of virtual machines and so forth using virtual resources is specified. The tenant used here has a purpose of managing, in the virtualization infrastructure 200, that the user is authorized to access what virtual resource. Basically, the user creates a virtual system on the tenant basis.

Then, the user makes changes to the virtual system as desired. With the changes made to the virtual system, the number of virtual machines and the usage states of virtual machines are changed, and the configuration of the virtual network is changed. Next, when the use of the virtual system is stopped, the user removes the virtual system. When the user no longer uses the virtualization infrastructure 200, the user deletes their account.

Note that these operations are performed in such a way that the user device 120 and the user device 130 request an acceptance server device 230 to perform processing, and, in accordance with the details of the processing, the acceptance server 230 requests one or more management components of the virtual machine management component 212, the virtual network management component 214, and the virtual storage management component 216 to perform the processing. At this point, the acceptance server device 230 may specify a suitable management component and request the specified management component to perform processing, by running a program in accordance with the processing details. In the embodiment section, a description will be given of an example in which a program is run in accordance with the processing details. Note that the acceptance server device 230 is, for example, implemented when a specific program is loaded into memory included in the server device 144 illustrated in FIG. 1 and this specific program is executed by the CPU of the server device 144.

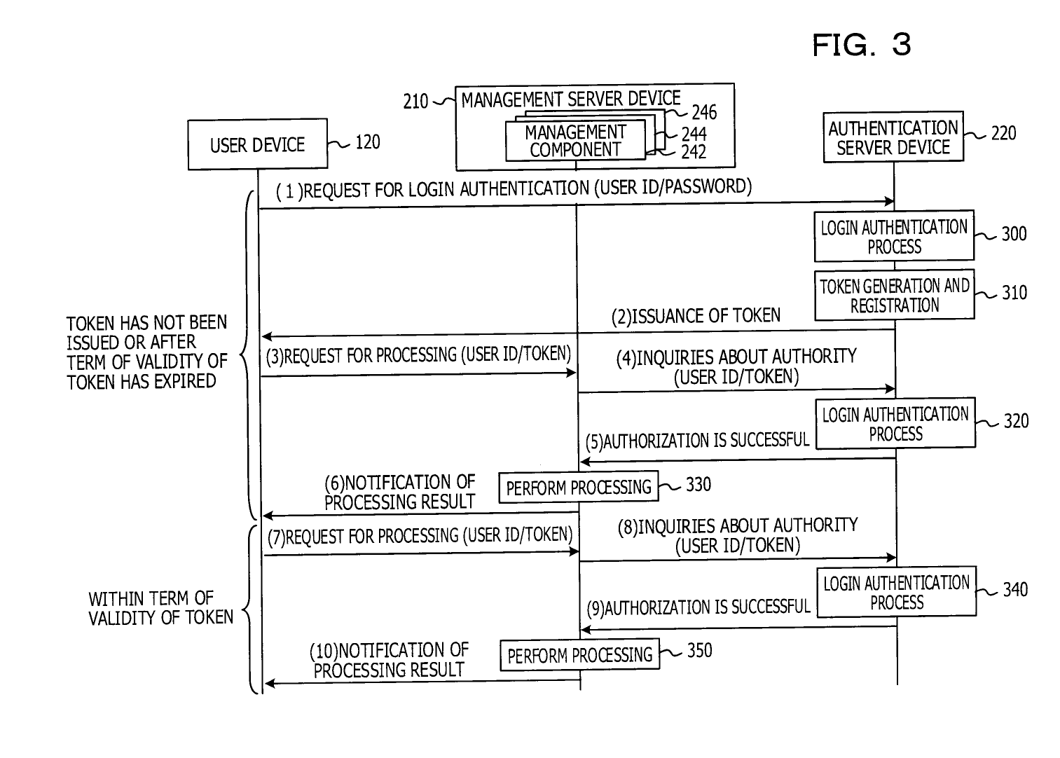

The virtual machine management component 212, the virtual network management component 214, and the virtual storage management component 216, upon reception of the request for processing, do not immediately perform the requested processing. As described in detail below in conjunction with FIG. 3, these components request an authentication server device 220 to perform a token authorization process to determine using a token, which is authorization information having a term of validity, whether or not to authorize the user who has requested the processing to use a virtual resource. Note that the authentication server device 220 is, for example, implemented when a specific program is loaded into memory included in the server device 142 illustrated in FIG. 1 and this specific program is executed by the CPU of the server device 142.

Note that this token is authorization information having a term of validity that is issued when, after creating an account, the user requests the authentication server device 220 to perform a login authentication process after which the login authentication process succeeds. When requesting, through the acceptance server device 230, one or more management components to perform processing, the user provides a notification of the token and the user ID as well as the request for processing. Using the notified token and user ID, the management components request the authentication server device 220 to perform a token authorization process.

In the embodiment, to deal with the processing requested by the user, when the token authorization process is requested, the authentication server device 220 is notified, through the one or more management components, of a program ID identifying a program run by the acceptance server device 230. Thus, the authentication server device 220 is able to identify the process requested by the user.

FIG. 3 illustrates an example of a login authentication process and token authorization processes at the time of using the virtualization infrastructure of the embodiment. Here, the login authentication process is a process of determining, using the user ID and a password associated with the user ID, whether or not the user in question is a registered user. This process is also referred to as a “user authentication process”. The token authorization process is a process in which it is determined using a token, which is authorization information having a term of validity issued to the user in question when the login authentication process is successful, whether or not to authorize the user in question to perform some operation on the virtualization infrastructure 200. This process is also referred to as a “user authorization process”. If the token, which is authorization information having a term of validity, has not been issued, or if the term of validity of the token has expired, since a token has to be obtained for use of the virtualization infrastructure 200, the user has to begin the login authentication process, to succeed in the login authentication, and to receive a token.

As illustrated in FIG. 3, when the login authentication process has to be performed, the user device 120 sends the user ID and the password to the authentication server device 220 and requests the authentication server device 220 to perform login authentication ((1) in FIG. 3). Note that there are some cases where the user device 130 makes a request for login authentication; however, the case where the user device 120 makes the request will be described here by way of example.

As described in detail below, the authentication server device 220, upon accepting the request for login authentication, performs a login authentication process 300, and, when the login authentication is successful, performs processing 310 of generating a token, which is authorization information having a term of validity, and registers the token in a database. Note that, when the token is registered in the database, the user ID and the token are registered in association with each other. Then, the generated token is issued to the user device 120 that has made the request ((2) in FIG. 3).

After the token is issued, using the issued token, the user device 120 requests the management server 210 to perform processing for using the virtualization infrastructure 200 ((3) in FIG. 3)).

Upon acceptance of this request, the management server device 210 assigns processing to one or more management components of the virtual machine management component 212, the virtual network management component 214, and the virtual storage management component 216, in accordance with the details of the processing. The management components to which processing is assigned check, prior to performing the assigned processing, whether or not the processing may be performed for the user. For the checking, using the user ID and the token, the one or more management components issue inquiries about the authority of the user to the authentication server device 220 ((4) in FIG. 3)).

The authentication server device 220 that has accepted the inquiries performs a token authorization process 320 by collating the sent user ID and token with the user ID and token already registered in the database. If the term of validity of the sent token has already expired, there is in the database no token that matches the sent token, and therefore the token authorization process fails. On the other hand, if it is determined in the token collation processing that the sent token is registered in the database, it is determined that the authorization process using the token for the user in question is successful. Then, the management components that have made inquiries about the authority are notified that authorization using the token is successful ((5) in FIG. 3).

Upon reception of the notification that authorization using the token is successful, the management components perform processing 330 for using the virtualization infrastructure 200 requested by the user device 120 and notify the user device 120 of the processing result ((6) in FIG. 3).

When the issued token is within the term of validity, the user device 120 may request the management server device 210 to perform another processing for using the virtualization infrastructure 200, without making a request for the login authentication process ((7) in FIG. 3).

Upon acceptance of this request, the management server device 210 assigns processing to one or more management components of the virtual machine management component 212, the virtual network management component 214, and the virtual storage management component 216, in accordance with the details of the processing. The management components to which processing is assigned check again, prior to performing the assigned processing, whether or not the processing may be performed for the user. For the checking, using the user ID and the token, the one or more management components issue inquiries about the authority of the user to the authentication server device 220 ((8) in FIG. 3)).

The authentication server device 220 that has accepted the inquiries performs a token authorization process 340 by collating the user ID and token sent with the user ID and token already registered in the database. Note that if the term of validity of the sent token has already expired, there is in the database no token that matches the sent token, and therefore the token authorization process fails. On the other hand, as illustrated in the drawing, when it is determined in this token collation processing that the sent token is registered in the database, it is determined that the authorization process using the token for the user in question is successful. Then, the management components that have made inquiries about the authority are notified that the authorization using the token is successful ((9) in FIG. 3).

Upon reception of the notification that authorization using the token is successful, the management components perform processing 350 for using the virtualization infrastructure 200 requested from the user device 120 and notify the user device 120 of the processing result ((10) in FIG. 3).

Note that, as described above, if the term of validity of the token has expired at the time at which the processing is requested, authorization is unsuccessful in the token collation of the processing 340. The user device 120 therefore has to receive a new token by repeating the login authentication process. Then, using the new token, the processing described above is requested again.

Note that the token generated when login authentication is successful is information generated in such a way that an attempt is made so that the information can be used to uniquely identify the user. By way of example, assuming that the time at which a request for login authentication is accepted is an input of a specific function, a symbol string obtained by execution of the function is included, in addition to the user ID and the password, in the token. Then, compared with an authorization process using a token described below, the login authentication process is higher in terms of processing load since the login authentication process includes the processing of generating a token in addition to the processing of collating a token with information within the database.

Additionally, as described above, a token is deleted from the database after the term of validity has expired. A token is also deleted when the account of the user is deleted. This is because the fact that the account of the user is deleted makes it possible to determine that the user concerned no longer has the intention to use the virtualization infrastructure 200 and the token does not have to be registered. However, if the user does not delete the account but removes the virtual system, the token may not be deleted. This is because even if the user stops using the virtual resource by removing the virtual system, the account of the user that has not been deleted indicates the possibility that the user has an intention of using the virtualization infrastructure again, and thus the token may remain in the database until the expiration date of the token. Note that one reason why the user does not delete the account while removing the virtual system could be that, in the case where the virtualization infrastructure 200 is used, the user removes assignment of virtual resources by removing the virtual system so that the user will not be charged for the assignment.

FIGS. 4A, 4B, and 4C illustrate examples of ways in which users use the virtualization infrastructure of the embodiment. In particular, FIG. 4A illustrates a usage manner of a user 1 for whom a virtual system is constructed in the virtualization infrastructure 200 and a service utilizing this virtual system is provided. FIG. 4B illustrates a usage manner of a user 2 for whom a virtual system constructed in the virtualization infrastructure 200 is regarded as an actual system and the system is evaluated using the virtual system. FIG. 4C illustrates an example of the usage manner from the point at which the user 2 constructs the virtual system until the user 2 performs a first analysis of a test result using the virtual system. Note that the number of days and the like illustrated in FIGS. 4A, 4B, and 4C are merely exemplary, and the embodiment is not limited to these examples.

As illustrated in FIG. 4A, the user 1 constructs a virtual system by performing system construction A11 and starts to provide, for example, a web service using the virtual system. After about 30 days have passed since the system construction A11, monthly maintenance operations of the virtual system are performed in accordance with the usage situation of the web service. For example, in accordance with an increase or a decrease in the number of users of the web service, a system change B11 such as a change in the number of virtual machines or a change in virtual machine specifications is performed. Then, successively, the web service is provided, and a system change B12 is performed as desired. Note that it is assumed that, during provision of the web service, the user 1 provides the service without changing the configuration of the virtual system.

The system construction A11 and the system changes B11 and B12 involve using virtual resources of the virtualization infrastructure 200. For this reason, when performing the system construction A11 and the system changes B11 and B12, using a configuration file describing specifications of virtual machines, the user 1 requests the management server device 210 to create a user account, to create a tenant for specifying the virtual system, and to arrange the virtual network and the virtual machine. For the processing mentioned, the login authentication process and the token authorization process described above are to be used.

However, once provision of the web service is started, the virtual system configuration itself is not changed, and thus the token authorization process is not performed. That is, during the period from the system construction A11 to the system change B12, the token is continuously registered in the database despite no token authorization process having occurred.

This will increase the opportunities for a malicious user to acquire the token concerned. In the token authorization process, at the worst, the collation processing occurs for all the tokens registered in the database. It is therefore desirable to delete from the database as many as possible of the tokens that are unlikely to be used.

In contrast, as illustrated in FIG. 4B and FIG. 4C, the user 2 regards a virtual system constructed in the virtual infrastructure 200 as an actual system, and evaluates the system concerned using the virtual system. The user 2 constructs a virtual system by performing a system construction A21. Then, the user 2 conducts tests for the virtual system in accordance with particular test patterns. Upon completion of the tests using one or more test patterns, the user 2 repeats the tests with another system configuration while performing the system changes B21 to B24. Then, upon completion of a series of tests, system removal C21 is performed and test results are analyzed. Then, upon completion of the analysis, a system is reconstructed with a system configuration based on the analysis. In such a way, the user 2 repeats evaluation of a system utilizing a virtual system and, upon completion of user account deletion D21, is finished with the project for 60 days.

Note that, when performing the system construction A21 and the system changes B21 to B24, which involve using virtual resources of the virtualization infrastructure 200, the user 2 has to perform the login authentication process and the token authorization process described above. However, during analysis of test results, no token authorization process occurs. That is, during this period, it is conceivable to delete the token from the database.

For the user 2, however, the system changes B21 to B24 are performed relatively frequently except during analysis periods. For this reason, if the token is deleted from the database during an analysis period in spite of an occurrence of a system change, the user 2 has to receive a new token by repeating the login authentication process. This results in less convenience. Since, as described above, the login authentication process is higher than the token authorization process in terms of processing load, repeating the login authentication process many times imposes a high load on the authentication server device 220.

In such a situation in which the usage manners of the user who uses the virtualization infrastructure 200 are diversified, it is desirable to balance the convenience for the user and the processing load to stop a token from being exposed to a malicious user.

To address this, according to the embodiment, the expiration date of authorization information having a term of validity used for an authorization process of the user is updated in accordance with a situation in which the authorization process for the user is requested. Therefore, authorization information registered in the database is maintained and deleted in accordance with this situation.

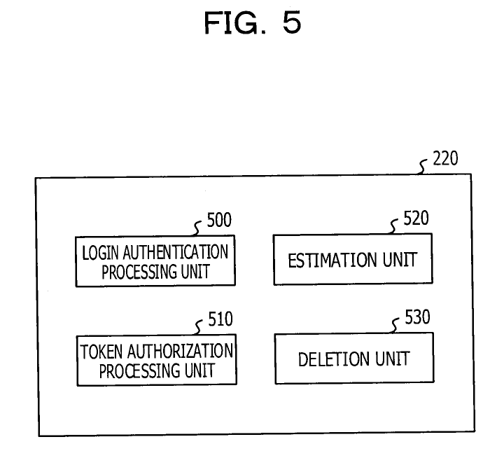

FIG. 5 illustrates an example of functional blocks of an authentication device of the embodiment. The authentication server device 220 illustrated in FIG. 2, which is an exemplary authentication device of the embodiment, functions as a login authentication processing unit 500, a token authorization processing unit 510, an estimation unit 520, and a deletion unit 530 when a program loaded into a memory used as a working memory is executed by the CPU of the authentication server device 220. The processing performed by these function units will be described below.

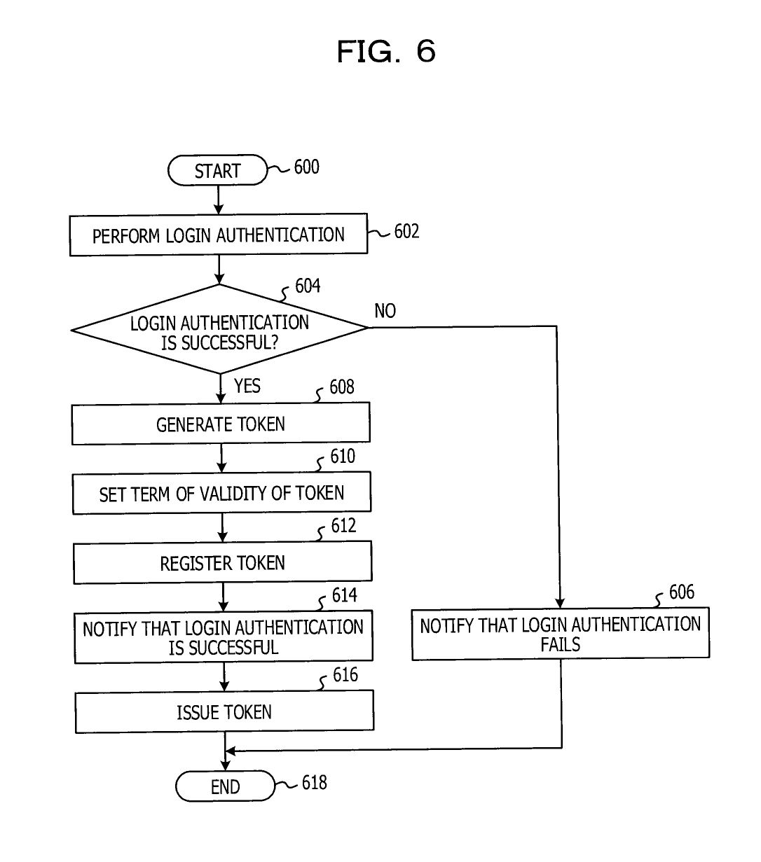

FIG. 6 illustrates an example of a login authentication process performed by the authentication device of the embodiment. The process illustrated in FIG. 6 is the login authentication process performed by the authentication server device 220 illustrated in FIG. 2. This login authentication process is started in processing 600 when a request for the login authentication process made by the user device 120 or the user device 130 illustrated in FIG. 2 is accepted.

Processing 602 of performing login authentication by using the user ID and the password is performed. In processing 602, the login authentication is performed by collating the user ID and the password that are notified along with a request for the login authentication process when the user device 120 or the user device 130 makes the request to the authentication server device 220, with a user ID and a password that are registered in a database when the account of the user is created.

Processing 604 of determining whether or not the login authentication is successful is performed. In processing 604, it is determined whether or not the notified user ID and password and the user ID and password registered in the database at the time of creating the account of the user, which are collated in processing 602, match.

When, in processing 604, it is determined that the login authentication fails, processing 606 of providing a notification of the failure of the login authentication is performed. Through processing 606, the user device 120 or the user device 130 that has made a request for the login authentication process is notified of the failure of the login authentication.

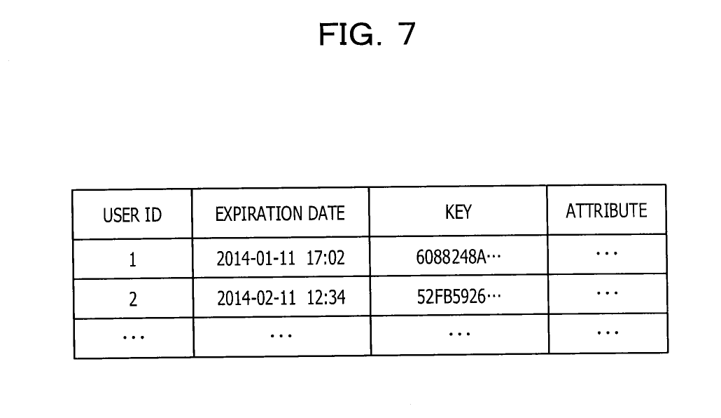

When, in processing 604, it is determined that the login authentication is successful, processing 608 of generating a token, which is authorization information having a term of validity, is performed. In processing 608, a token is generated in such a way that an attempt is made so that the information can be used to uniquely identify the user. For example, assuming that the time at which a request for login authentication is accepted is an input of a specific function, a symbol string obtained by execution of the function is included, in addition to the user ID and the password, in the token. Note that an example of the symbol string is a KEY described below in conjunction with FIG. 7.

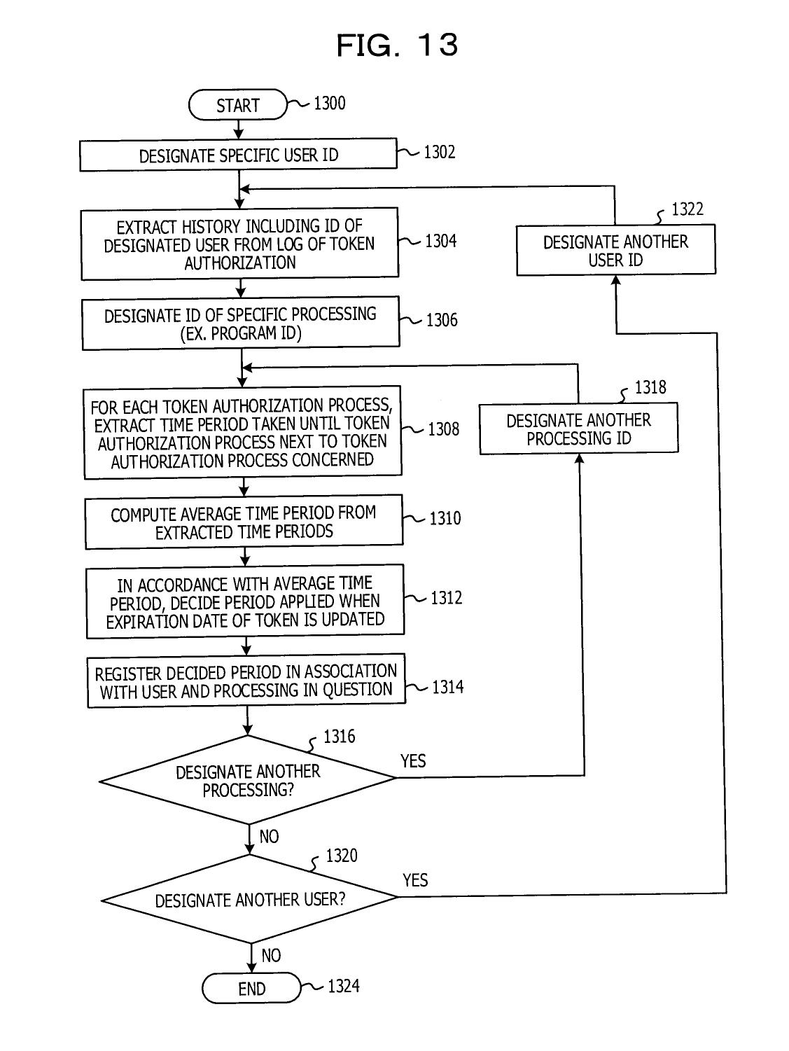

Processing 610 of setting the expiration date of the token, which is authorization information having a term of validity, is performed. In processing 610, the expiration date is set based on an update rule described below in conjunction with FIG. 13. Note that if, at the time of processing 610, the update rule based on the history of the token authorization process has not yet been created, the default value may be set.

Processing 612 of registering the expiration date of the token, which is authorization information having a term of validity is performed. In processing 612, the expiration date set in processing 610 and the user ID are associated with the KEY generated in processing 608 and are registered in a database.

Processing 614 of issuing a notification that login authentication is successful is performed. Through processing 614, the user device 120 or the user device 130 that has made a request for the login authentication process is notified that login authentication is successful.

Processing 616 of issuing the token, which is authorization information having the term of validity, is performed. Through processing 616, the token, which is authorization information having a term of validity, is issued to the user device 120 or the user device 130 that has made a request for the login authentication process. In processing 618, the login authentication process is completed.

FIG. 7 depicts an example of a token that is authorization information having a term of validity of the embodiment. The token that is authorization information having a term of validity depicted in FIG. 7 is a token generated in processing 608 illustrated in FIG. 6, and is information stored on a storage device coupled to the authentication server device 220 illustrated in FIG. 2.

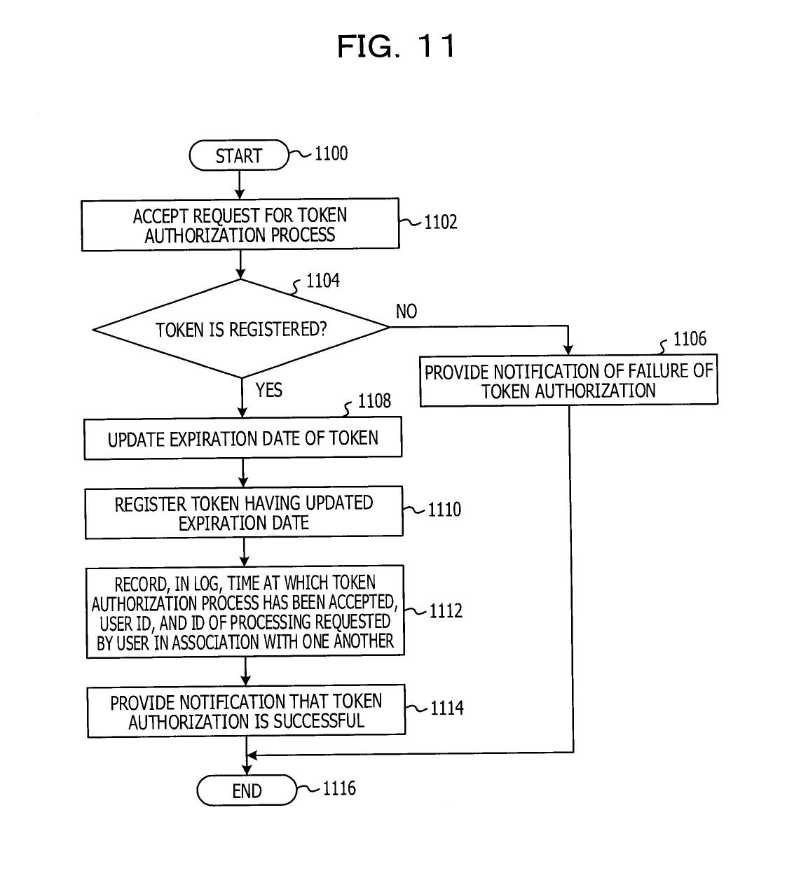

The token includes a user ID, an expiration date, a KEY, and an attribute, which are mutually associated. For example, a KEY generated in processing 608 and the expiration date set in processing 610 are associated with the user ID. In FIG. 7, it is indicated that, for example, the expiration date of a token issued to a user having a user ID “1” is “2014-01-11 17:02” and the KEY generated for uniquely identifying the token is “6088248A . . . ”. Additionally, in the token, a specific attribute may be registered in association with the user ID. Then, the token is referred to in the token authorization process described below in conjunction with FIG. 11.

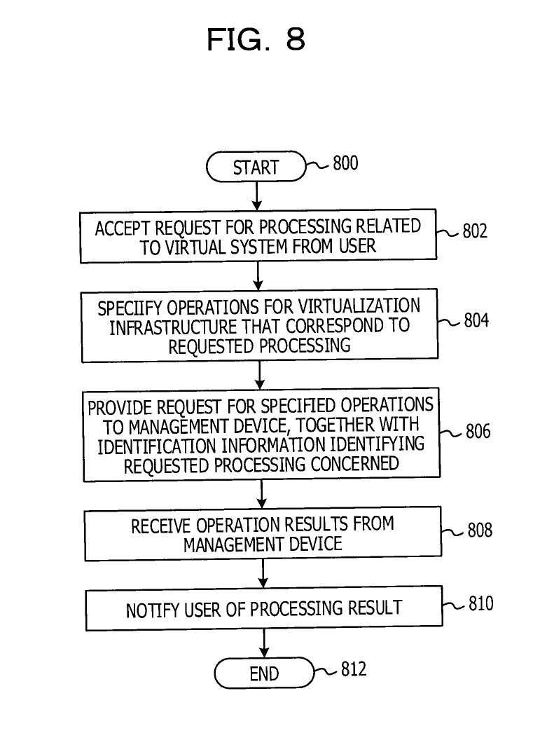

FIG. 8 illustrates an example of a process performed by an acceptance device of the embodiment. The process illustrated in FIG. 8 is a process performed by the acceptance server device 230 illustrated in FIG. 2, and is started in processing 800.

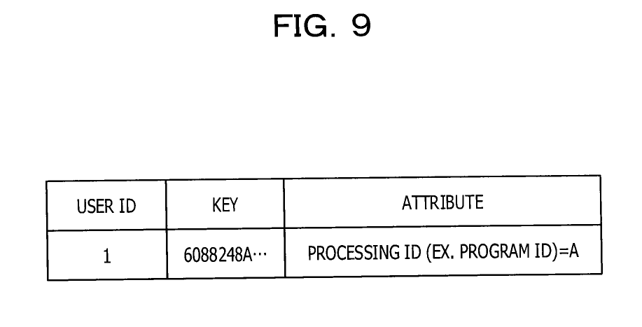

Processing 802 of accepting a request from a user for processing related to a virtual system is performed. In processing 802, processing related to a virtual system requested by the user device 120 or the user device 130 illustrated in FIG. 2 is accepted. Here, the processing related to a virtual system includes, for example, the system construction, system changes, system removal, system deletion, and the like illustrated in FIG. 4A to FIG. 4C. Note that the user provides a request for processing to the acceptance server device 230, together with information for a token authorization process described below in conjunction with FIG. 9 and a configuration file describing specifications expected for the virtual system.

Processing 804 of specifying operations for the virtualization infrastructure 200 that correspond to the requested processing is performed. In processing 804, one or more operations for the virtualization infrastructure 200 that are desired to implement the processing requested in processing 802 are specified. Then, in the subsequent processing 806, one or more management components of the virtual machine management component 212, the virtual network management component 214, and the virtual storage management component 216 in the management server device 210 are requested to perform the specified one or more operations.

For example, when, in processing 802, the user makes a request for a system change such as increasing the number of virtual machines, in processing 804, an operation of newly arranging a virtual machine and an operation of coupling the new arranged virtual machine to the virtual network are specified as desired operations.

Processing 806 of providing a request for the specified operations to a management device, together with identification information for identifying the requested processing concerned, is performed. In processing 806, for example, when, in processing 802, the user makes a request for a system change such as increasing the number of virtual machines, a request for operations of newly arranging virtual machines is provided, together with identification information indicating that the requested processing is the system change, to the virtual management component 212. For an operation of coupling the newly arranged virtual machine to the virtual network, a request for the operation is provided, together with identification information indicating that the requested processing is the system change, to the virtual network management component 214. Note that, for these operation requests, one or more management components are notified of information for the token authorization process and the user ID described below in conjunction with FIG. 9.

Note that processing 804 and processing 806 may be performed by a particular program corresponding to the specified one or more operations, but the embodiment is not limited to this. The existence of the program enables the user to use the virtual system merely by designating specifications expected for the virtual system. Then, in the case where processing requested by the user is able to be associated with the program, using a program ID identifying the program as identification information for identifying the requested processing, a request for operations may be provided together with the program ID to one or more management components.

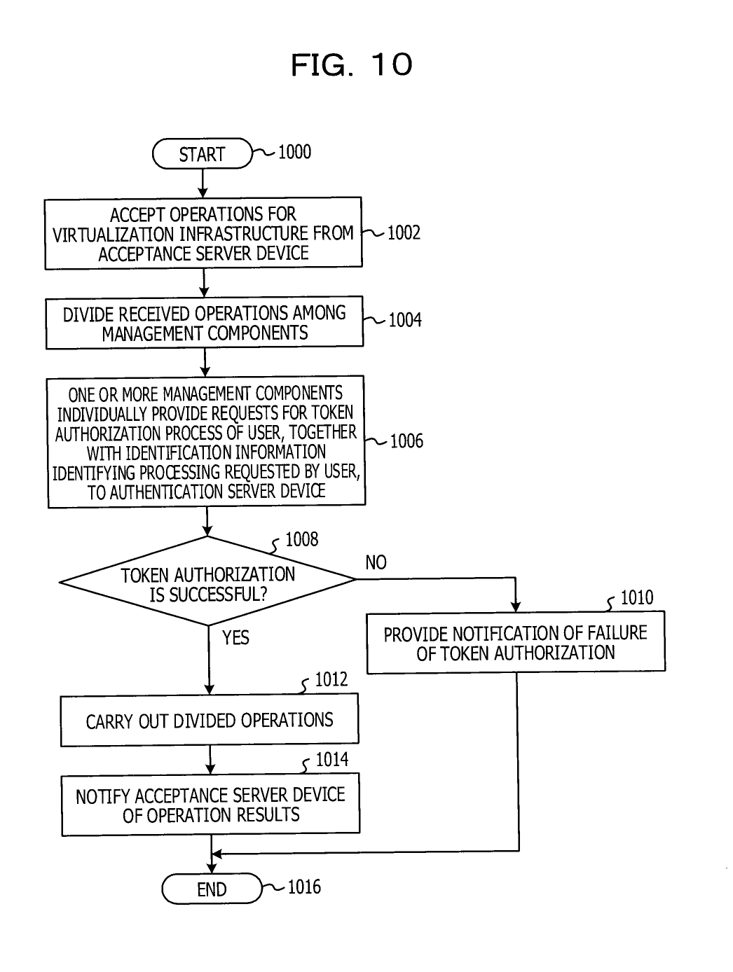

Processing 808 of receiving operation results from a management device is performed. In processing 808, the management server device 210 receives results of the operations requested in processing 806. Note that the operations carried out by the management server device 210 will be described below in conjunction with FIG. 10.

Processing 810 of notifying the user of a processing result is performed. In processing 810, based on the operation results received in processing 808, the user is notified of a result of processing. The notification tells the user that the requested processing has been performed as expected and thus the desired virtual system becomes available, or the desired virtual system is not available. Then, in processing 812, the process illustrated in FIG. 8 is completed.

FIG. 9 depicts an example of information for a token authorization process of which the authentication device of the embodiment is notified. Information indicated here is, as illustrated at (3) and (7) in FIG. 3, information that is provided along with a request for processing related to the virtual system and that includes a user ID, a KEY included in a token issued at (2) in FIG. 3, and identification information for identifying requested processing.

As depicted in FIG. 9, “6088248A . . . ”, which is the issued KEY, and a processing ID (for example, the program ID mentioned above) for identifying requested processing are associated with the user ID.

FIG. 10 illustrates an example of a process performed by a management device of the embodiment that manages virtual resources. The process illustrated in FIG. 10 is a process performed by the management server device 210 illustrated in FIG. 2, and, in accordance with the details of the processing, is performed by the virtual machine management component 212, the virtual network management component 214, or the virtual storage management component 216. The process illustrated in FIG. 10 is started in processing 1000.

Processing 1002 of accepting operations for the virtualization infrastructure from the acceptance server device is performed. In processing 1002, one or more operations for the virtualization infrastructure requested by the acceptance server device 230 in processing 806 mentioned above are accepted.

Processing 1004 of dividing the accepted operations among management components is performed. In processing 1004, one or more operations accepted in processing 1002 are divided among the corresponding one or more management components of the virtual machine management component 212, the virtual network management component 214, and the virtual storage management component 216.

Processing 1006 is performed in which one or more management components individually provide requests for the token authorization process of the user, together with identification information for identifying processing requested by the user, to an authentication server device. In processing 1006, before the operations divided in processing 1004 are carried out, the authentication server device 220 is requested to perform the token authorization process in order to determine whether or not the user is to be authorized to use the virtualization infrastructure 200. The request for this token authorization process is provided together with information for the token authorization process provided by the user, which is described above in conjunction with FIG. 9, and identification information for identifying processing requested by the user.

Processing 1008 of determining whether or not the token authorization is successful is performed. In processing 1008, a result of the token authorization process requested in processing 1006 is received from the authentication server device 220, and, based on the result, it is determined whether or not the token authorization is successful.

When, in processing 1008, it is determined that the token authorization fails, processing 1010 of providing a notification of the failure of the token authorization is performed. Through processing 1010, the user is notified of the failure of the token authorization via the acceptance server device 230.

When, in processing 1008, it is determined that the token authorization is successful, processing 1012 of carrying out the divided operations is performed. In processing 1012, the operations divided in processing 1004 are carried out by management components.

Processing 1014 of notifying the acceptance server device of operation results is performed. Through processing 1014, the acceptance server device 230 is notified of results of operations carried out in processing 1012. Then, in processing 1016, the process illustrated in FIG. 10 is completed.

FIG. 11 illustrates an example of a token authorization process performed by the authentication device of the embodiment. The token authorization process illustrated in FIG. 11 is an authorization process performed by the token authorization processing unit 510 of the authentication server device 220 illustrated in FIG. 2. This token authorization process is a process requested by the virtual machine management component 212, the virtual network management component 214, or the virtual storage management component 216 in the management server device 210, the process arising from processing related to the virtual system requested by the user device 120 or the user device 130 illustrated in FIG. 2. The process illustrated in FIG. 11 is started in processing 1100.

Processing of accepting a request for a token authorization process is performed in processing 1102. Through processing 1102, a token authorization process requested by the virtual machine management component 212, the virtual network management component 214, or the virtual storage management component 216 is accepted. Note that the request for the token authorization process is, as described above on the processing 1006 illustrated in FIG. 10, provided along with information for the token authorization process provided from the user and identification information for identifying processing requested by the user.

Processing 1104 of determining whether or not a token is registered is performed. In processing 1104, it is determined whether or not a token including a KEY that matches a KEY in the information for the token authorization process provided from the user is registered in the database. More specifically, it is determined whether or not the token concerned is registered in the database by, for a plurality of tokens registered in the database, sequentially collating a KEY included in each token with the KEY in the provided information.

When, in processing 1104, it is determined that the token is not registered, processing 1106 of providing a notification of the failure of token authorization is performed. Through processing 1106, the virtual machine management component 212, the virtual network management component 214, or the virtual storage management component 216 that has made a request for the token authorization process is notified of the failure of the token authorization process.

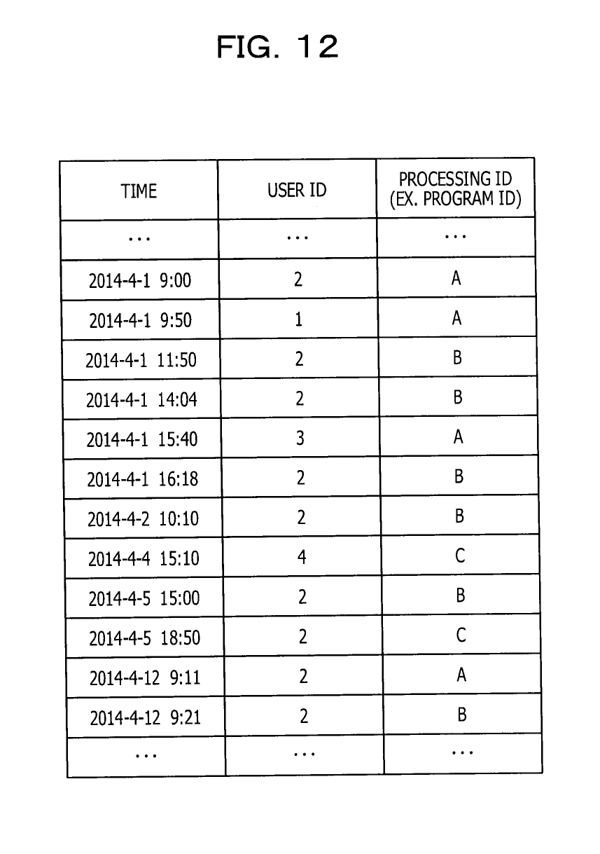

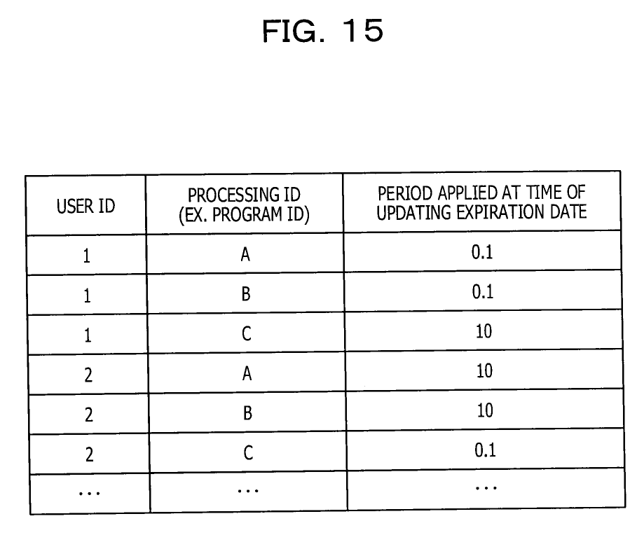

When, in processing 1104, it is determined that the token is registered, processing 1108 of updating the expiration date of the token is performed. In processing 1108, the expiration date is updated in compliance with the update rule depicted in FIG. 12. As described below in conjunction with FIG. 15, the update rule is created in accordance with the usage situation of the virtualization infrastructure 200 of the user. Consequently, through processing 1108, the expiration date of the token is updated in accordance with the usage situation of the virtualization infrastructure 200 of the user. For example, as illustrated in FIG. 15, if a user having a user ID “1” requests processing with a processing ID “A” after the successful token authorization process, the token is updated so that the duration of the validity extends by “0.1 days”.

Processing 1110 of registering the token having an updated expiration date is performed. In processing 1110, the existing expiration date is overwritten with the updated expiration date through processing 1108, and the token having the updated expiration date is newly registered in the database.

Processing 1112 of storing, in a log, the time at which the token authorization process has been accepted, the user ID, and the identification information for identifying processing requested by the user in association with one another is performed. Through processing 1112, a log described below in conjunction with FIG. 12 is generated.

Processing 1114 of providing a notification that the token authorization is successful is performed. Through processing 1114, the virtual machine management component 212, the virtual network management component 214, or the virtual storage management component 216 that has made a request for the authorization process is notified that the token authorization process is successful. Then, in processing 1116, the process illustrated in FIG. 11 is completed.

FIG. 12 depicts an example of a log stored by the authentication device of the embodiment. The log depicted in FIG. 12 is a log stored by the process described above in conjunction with processing 1112 of FIG. 11. Additionally, the usage situation of the virtualization infrastructure 200 of the user described in conjunction with FIG. 4A to FIG. 4C may be indirectly recognized using a log message of the token authorization process in this log.

For example, use of the virtualization infrastructure 200 by a user having a user ID “2” at a time “2014-4-1 9:00” is recorded using a log message of a token authorization process that has occurred in association with the use. It is also recorded that the token authorization process at this time has arisen from processing identified by the processing ID “A”. That is, it is recognizable that the token authorization process arising from the system construction A of the virtual system made by the user having the user ID “2” has occurred at the time “2014-4-1 9:00”.

Note that, as described below, through a process illustrated in FIG. 13, the average time period from the occurrence of a token authorization process to the occurrence of the next token authorization process is computed for each kind of processing from which a token authorization process arises, and, using the computed average time period, it is determined how much extension of the term of validity of a token would be desirable.

FIG. 13 illustrates an example of an update rule creation process performed by the authentication device of the embodiment. The update rule creation process illustrated in FIG. 13 is a process performed by the estimation unit 512 of the authentication server device 220 illustrated in FIG. 2. This process is a process in which, using the log depicted in FIG. 12, the duration applied at the time of extending the term of validity of a token is estimated for each kind of processing, based on the history of processing performed by a specific user, and, as a result, an update rule for the duration applied at the time of extending the term of validity of a token is created. The process is started in processing 1300.

Processing 1302 of designating a specific user is performed. In processing 1302, designation of a specific user is made by designating the user ID. For example, in description of an example with reference to FIG. 12, designating “2” as the user ID corresponds to processing 1302.

Processing 1304 of extracting a history including the ID of the designated user from the log of the token authorization process is performed. In processing 1304, the history of the token authorization process for the user concerned is extracted by collecting records related to the user ID designated in processing 1302 in the log depicted in FIG. 12. For example, in the log depicted in FIG. 12, records of a token authorization process that has arisen from processing requested by the user having the user ID “2” are collected. More specifically, the record of a token authorization process that has arisen at the time “2014-4-1 9:00” from the processing having the processing ID “A” requested by the user having the user ID “2” is extracted. The record of a token authorization process that has arisen at a time “2014-4-1 11:50” from the processing having a processing ID “B” requested by the user having the user ID “2” is also extracted. The record of a token authorization process that has arisen at a time “2014-4-1 14:04” from the processing having the processing ID “B” requested by the user having the user ID “2” is also extracted. The record of a token authorization process that has arisen at a time “2014-4-1 16:18” from the processing having the processing ID “B” requested by the user having the user ID “2” is also extracted. The record of a token authorization process that has arisen at a time “2014-4-2 10:10” from the processing having the processing ID “B” requested by the user having the user ID “2” is also extracted. The record of a token authorization process that has arisen at a time “2014-4-5 15:00” from the processing having the processing ID “B” requested by the user having the user ID “2” is also extracted. The record of a token authorization process that has arisen at a time “2014-4-5 18:50” from the processing having a processing ID “C” requested by the user having the user ID “2” is also extracted. The record of a token authorization process that has arisen at a time “2014-4-12 9:11” from the processing having the processing ID “A” requested by the user having the user ID “2” is also extracted. The record of a token authorization process that has arisen at a time “2014-4-12 9:21” from the processing having the processing ID “B” requested by the user having the user ID “2” is also extracted.

Processing 1306 of designating the ID of specific processing is performed. In processing 1306, for example, in the records of the user ID “2” depicted in FIG. 12, records of the processing ID “A” are designated.

In each token authorization process associated with the ID of the designated processing, processing 1308 of extracting the time period taken after a token authorization process in question until performing the next token authorization process is performed. In processing 1308, the time period taken after the token authorization process that has arisen from specific processing of a user until a token authorization process that has arisen from the next processing requested by the same user is extracted. Note that the next processing may be another kind of processing, independently of the specific processing.

An example will be described with reference to FIG. 12. For example, when the processing ID “A” is designated through processing 1306, the token authorization process that has arisen at the time “2014-4-1 9:00” from processing having the ID “A” requested by the user having the user ID “2” is followed by the token authorization process that has arisen at the time “2014-4-1 11:50” from the next processing requested by the user having the user ID “2”. In this case, in the token authorization process associated with the ID of the designated processing, the time period taken after the token authorization process in question until the next token authorization process is “2 hours and 50 minutes”.

In the log depicted in FIG. 12, the token authorization process that has arisen at the time “2014-4-12 9:11” from processing having the ID “A” requested by the user having the user ID “2” is followed by the token authorization process that has arisen at the time “2014-4-12 9:21” from the next processing requested by the user having the user ID “2”. In this case, in the token authorization process associated with the ID of the designated processing, the time period taken after the token authorization process in question until the next token authorization process is “10 minutes”.

Processing 1310 of computing an average time period from extracted time periods is performed. In processing 1310, the average time period of time periods extracted through processing 1308 is computed. In the example mentioned above, the time periods are “2 hours and 50 minutes” and “10 minutes”, and thus the average time period is “1 hour and 30 minutes”.

In this embodiment, when a token authorization process arising from processing having the processing ID “A” requested by the user having the user ID “2” is performed, this average time period is estimated as a time period taken until a token authorization process arising from processing requested next by the user having the user ID “2” will occur.

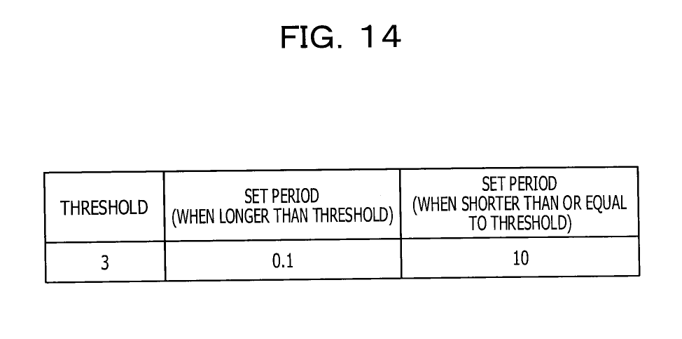

Here, prior to describing processing 1312, the determination criterion depicted in FIG. 14 will be described.

FIG. 14 depicts an example of a determination criterion referred to when the update rule of the embodiment is created. The determination criterion includes a threshold, a set period applied when the average time period computed in processing 1310 is longer than the threshold, and a set period applied when the average time period computed in processing 1310 is less than or equal to the threshold. FIG. 14 depicts, by way of example, that, in the case where the threshold is “3 days”, the set period applied when the average time period computed in processing 1310 is longer than the threshold is “0.1 days” and the set period applied when the average time period computed in processing 1310 is less than or equal to the threshold is “10 days”. Note that a criterion that is different for each user may be set as the determination criterion. The determination criterion may be changed in accordance with the usage manner of the user.

Turning now to FIG. 13, description will be given. Processing 1312 of deciding, in accordance with the average time period, a period applied at the time of updating the expiration date of a token is performed. In processing 1312, using the average time period computed through processing 1310 and the determination criterion depicted in FIG. 14, the period applied at the time of updating the expiration date of a token is decided.

For example, in the example described above, when a token authorization process arising from processing having the processing ID “A” requested by the user having the user ID “2” is performed, the average time period taken until a token authorization process arising from processing requested next by the user having the user ID “2” occurs is “1 hour and 30 minutes”. In processing 1312, this average time period is compared with the threshold “3 days” set in the determination criterion of FIG. 14. As a result of comparison, the average time period is shorter than the threshold “3 days”, and the set period is decided as “10 days”. Then, through processing 1314 described below, the setting period is registered as an update rule depicted in FIG. 15.

Thus, when a token authorization process arising from processing having the processing ID “A” requested by the user having the user ID “2” is successful, the update rule is referred to in processing 1108 described above, so that the expiration date of the token is updated to a time obtained by adding “10 days” to the time at which the token authorization process has succeeded.

The average time period described above being short implies that the user tends to immediately make a request for some processing for a virtual system, and thus implies that a token authorization process is very likely to immediately occur. If, despite of such a usage tendency of the user, the token is deleted from the database, the user has to perform a login authentication process and receive a token once again. This results in less convenience. On the other hand, as described below, the average time period being long implies that the period taken until the next processing for a virtual system is requested is long, and thus implies that a token authorization process is less likely to occur. With such a usage tendency, it is considered that although a login authentication process will occur again, the token may be deleted from the database in order to alleviate the load of a token authorization process for other users and reduce the risk that a token will be stolen by a malicious user.

As such, according to the embodiment, attention is focused on specific processing of some user. The average time period taken until the next processing requested following the specific processing is computed from the history of token authorization processes that have arisen from these stages of processing. Then, using the average time period, the usage tendency of the user after the specific processing is estimated. Thus, the duration for which the term of validity of a token is to extend is decided. The duration will be applied in the future when a token authorization process that has arisen from the same kind of processing as the specific processing is successful.

Processing 1314 of registering the decided period in association with the user and processing in question is performed. In processing 1314, the period estimated through processing 1312 is associated with the designated user and the designated processing and is registered as an update rule. For example, the period “10 days” is associated with the user ID “2” and the processing ID “A” and is registered as an update rule. Note that the update rule will be described below in conjunction with FIG. 15.

Processing 1316 of determining whether or not to designate another processing is performed. In processing 1316, for the user designated in processing 1302, it is determined whether or not to designate another processing, in order to estimate the usage tendency for the other processing. When it is determined that the other processing is not to be designated, the process proceeds to processing 1320.

When, in processing 1316, it is determined that the other processing is to be designated, processing 1318 of designating another processing ID is performed. Here, the case where the processing ID “B” is designated as another processing ID and subsequently processing 1308 is performed is described with reference to FIG. 12. In this case, the token authorization process that has arisen at the time “2014-4-1 11:50” from processing having the ID “B” requested by the user having the user ID “2” is followed by the token authorization process that has arisen at the time “2014-44 14:04” from the next processing requested by the user having the user ID “2”. In this case, in the token authorization process associated with the ID of the designated processing, the time period taken after the token authorization process in question until the next token authorization process is “2 hours and 14 minutes”.

In the log depicted in FIG. 12, the token authorization process that has arisen at the time “2014-4-1 14:04” from processing having the ID “B” requested by the user having the user ID “2” is followed by the token authorization process that has arisen at the time “2014-4-1 16:18” from the next processing requested by the user having the user ID “2”. In this case, in the token authorization process associated with the ID of the designated processing, the time period taken after the token authorization process in question until the next token authorization process is “2 hours and 14 minutes”.

In the log depicted in FIG. 12, the token authorization process that has arisen at the time “2014-4-1 16:18” from processing having the processing ID “B” requested by the user having the user ID “2” is followed by the token authorization process that has arisen at the time “2014-4-2 10:10” from the next processing requested by the user having the user ID “2”. In this case, in the token authorization process associated with the ID of the designated processing, the time period taken after the token authorization process in question until the next token authorization process is “17 hours and 52 minutes”.

In the log depicted in FIG. 12, the token authorization process that has arisen at the time “2014-4-2 10:10” from processing having the processing ID “B” requested by the user having the user ID “2” is followed by the token authorization process that has arisen at the time “2014-4-5 15:00” from the next processing requested by the user having the user ID “2”. In this case, in the token authorization process associated with the ID of the designated processing, the time period taken after the token authorization process in question until the next token authorization process is “76 hours and 50 minutes”.

In the log depicted in FIG. 12, the token authorization process that has arisen at the time “2014-4-5 15:00” from processing having the processing ID “B” requested by the user having the user ID “2” is followed by the token authorization process that has arisen at the time “2014-4-5 18:50” from the next processing requested by the user having the user ID “2”. In this case, in the token authorization process associated with the ID of the designated processing, the time period taken after the token authorization process in question until the next token authorization process is “3 hours and 50 minutes”.

Subsequently, for the processing ID “B” of the user having the user ID “2”, processing 1310 of computing an average time period from the extracted time periods is performed. The average time period in this example is “20 hours and 36 minutes”. Then, when a token authorization process arising from processing having the processing ID “B” requested by the user having the user ID “2” is performed, this average time period is estimated as a time period taken until the occurrence of a token authorization process arising from processing requested next by the user having the user ID “2”. Note that, for processing that occurs very frequently, like processing having the processing ID “B”, a token authorization process also occurs very frequently. For this reason, in order to make a token unlikely to be deleted from the database, the time period obtained by multiplying the computed average time period by a coefficient less than or equal to one in accordance with the occurrence frequency may be dealt with anew as an average time period.

Subsequently, for the processing ID “B” of the user having the user ID “2”, processing 1312 of deciding, in accordance with the average time period, a period applied at the time of updating the expiration date of a token is performed. In the case of this example, when a token authorization process arising from processing having the processing ID “B” requested by the user having the user ID “2” is performed, this average time period taken until a token authorization process arising from processing requested next by the user having the user ID “2” is “20 hours and 36 minutes”. In processing 1312, this average time period is compared with the threshold “3 days” set in the determination criterion of FIG. 14. As a result of comparison, the average time period “20 hours and 36 minutes” is shorter than the threshold “3 days”, and the set period is decided as “10 days”. Then, through processing 1314 described above, the set period is registered as an update rule depicted in FIG. 15.

Thus, when a token authorization process arising from processing having the processing ID “B” requested by the user having the user ID “2” is successful, the update rule is referred to in processing 1108 described above, so that the expiration date of the token is updated to a time obtained by adding “10 days” to the time at which the token authorization process has succeeded.

When processing 1318 of designating another processing ID is performed, the case where a processing ID “C” is designated and subsequently processing 1308 is performed will be described with reference to FIG. 12.

In this case, the token authorization process that has arisen at the time “2014-4-5 18:50” from processing having the ID “C” requested by the user having the user ID “2” is followed by the token authorization process that has arisen at the time “2014-4-12 9:11” from the next processing requested by the user having the user ID “2”. In this case, in the token authorization process associated with the ID of the designated processing, the time period taken after the token authorization process in question until the next token authorization process is “158 hours and 21 minutes”.

Subsequently, processing 1310 of computing an average time period from extracted time periods is performed for the processing ID “C” of the user having the user ID “2”. The average time period of this example is “158 hours and 21 minutes”. Then, when a token authorization process arising from processing having the processing ID “C” requested by the user having the user ID “2” is performed, this average time period is estimated as a time period taken until the occurrence of a token authorization process arising from processing requested next by the user having the user ID “2”.

Subsequently, for the processing ID “C” of the user having the user ID “2”, processing 1312 of deciding, in accordance with the average time period, a period applied at the time of updating the expiration date of a token is performed. In the case of this example, when a token authorization process arising from processing having the processing ID “C” requested by the user having the user ID “2” is performed, this average time period taken until a token authorization process arising from processing requested next by the user having the user ID “2” is “158 hours and 21 minutes”. In processing 1312, this average time period is compared with the threshold “3 days” set in the determination criterion of FIG. 14. As a result of comparison, the average time period “158 hours and 21 minutes” is longer than the threshold “3 days”, and the set period is decided as “0.1 days”. Then, through processing 1314 described above, the set period is registered as an update rule depicted in FIG. 15.

Thus, when a token authorization process arising from processing having the processing ID “C” requested by the user having the user ID “2” is successful, the update rule is referred to in processing 1108 described above, so that the expiration date of the token is updated to a time obtained by adding “0.1 days” to the time at which the token authorization process has succeeded.

In such a manner, the average time period being long implies that the period taken until the next processing for a virtual system is long, and thus implies that a token authorization process is less likely to immediately occur. With such a usage tendency, it is considered that although a login authentication process will occur again, the token may be deleted from the database in order to alleviate the load of a token authorization process for other users and reduce the risk that a token will be stolen by a malicious user. That is, when a token authorization process that has arisen from processing having the processing ID “C” requested by the user having the user ID “2” is successful, the period that will elapse before processing requested next is estimated to be long. In order to facilitate deleting the token from the database, the expiration date is updated so that the duration of validity of the token is rather short.

When, in processing 1316, it is determined that another processing is not to be designated, processing 1320 of determining whether to designate another user is performed. The determining of processing 1320 is processing for deciding whether or not to create an update rule applied to another user. If update rules are to be created for all the users, the user designation may be repeated until no user who has not been designated remains.

When, in processing 1320, it is determined that another user is to be designated, processing 1322 of designating another user is performed. Upon performing processing 1322, the process proceeds to processing 1304.

When, in processing 1320, it is determined that another user is not to be designated, the process proceeds to processing 1324 and the process illustrated in FIG. 13 is completed.

FIG. 15 depicts an example of an update rule for updating the expiration date of the authorization information having a term of validity of the embodiment. The update rule is information created by performing the process illustrated in FIG. 13 based on the log depicted in FIG. 12.

For example, when a token authorization process arising from processing having the processing ID “A” requested by the user having the user ID “1” is successful, mutual information is associated with each other so that the period applied at the time of updating the expiration date of the token is “0.1 days”. This is, for example, an example applied to the token of the user 1 whose usage tendency is illustrated in FIG. 4A. Since, after constructing a virtual system, the user 1 offers a service without changing the system configuration of this virtual system, according to the embodiment, the expiration date is updated so that the token is more likely to be deleted from the database.

In the update rule, in contrast, when a token authorization process arising from processing having the processing ID “A” requested by the user having the user ID “2” is successful, mutual information is associated with each other so that the period applied at the time of updating the expiration date of the token is “10 days”. This is, for example, an example applied to the token of the user 2 whose usage tendency is illustrated in FIG. 4B and FIG. 4C. Since, after constructing a virtual system, the user 2 tends to change the system configuration of the virtual system, a token authorization process occurs without a relatively long time interval between the construction and the change. Therefore, according to the embodiment, the expiration date is updated so that the authorization information is less likely to be deleted from the database.

Note that, in this update rule, the period applied at the time of updating the expiration date of a token may be set using the dependence between processing and processing requested by the user. For example, if processing A is performed and subsequently processing B related to the processing A is performed as a series of processing, the update rule may be set in such a manner that, after an authorization process arising from the processing A has succeeded, the expiration date of the token is updated so that the extended duration of validity is rather long, and, as a result, the token is maintained in the database until an authorization process arising from the processing B occurs.

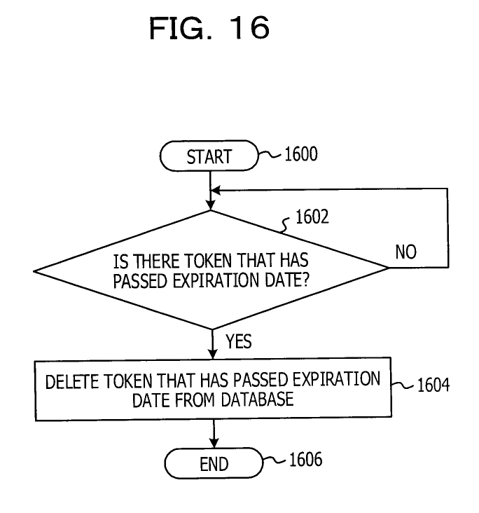

FIG. 16 illustrates an example of a process of deleting a token, which is authorization information having a term of validity, performed by the authentication device of the embodiment. The deletion process illustrated in FIG. 16 is a process performed by the deletion unit 530 of the authentication server device 220 illustrated in FIG. 2. The process is started in processing 1600.

Processing 1602 of determining whether or not there is a token that has passed the expiration date. In processing 1602, using the expiration date of the token registered in the database, it is determined whether or not there is a token that has passed the expiration date. When there is no token that has passed the expiration date, processing 1602 is repeated.

Processing 1604 of deleting, from the database, the token that has passed the expiration date is performed. When, as a result of determination of processing 1602, there is a token that has passed the expiration date, the token is deleted from the database through processing 1604.

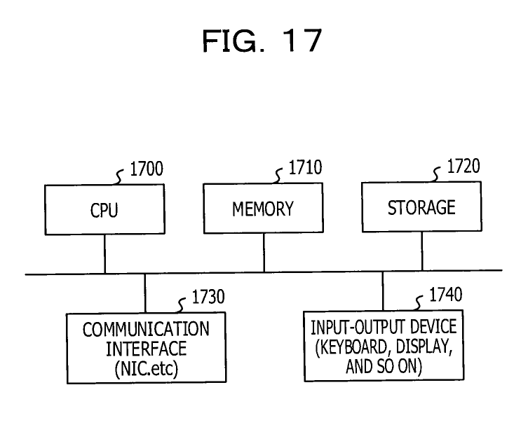

FIG. 17 illustrates an example of a hardware configuration of each device of the embodiment. The user device 120, the user device 130, the server device 140, the server device 142, the server device 144, the server device 146, and the server device 148 are basic computers. Each of the devices has a basic hardware configuration of a computer illustrated in FIG. 17. This hardware configuration includes a CPU 1700, a memory 1710, a storage 1720, a communication interface 1730, and an input-output device 1740 that are mutually coupled via a bus. Note that the storage 1720 is the storage device 150 and the storage device 152 illustrated in FIG. 1 and the like.

In the memory 1710, programs for performing various kinds of processing are stored. The CPU 1700 reads programs from the memory 1710 and performs various kind of processing. As various kinds of processing to be performed by the CPU 1700 are performed, data is written to and read from the memory 1710.

The CPU 1700 transfers data to the communication interface 1730. The CPU 1700 reads data from the storage 1720 and also writes data to the storage 1720.

The CPU 1700 may include one or more CPU cores for performing various kinds of processing. Each CPU core may include one or more processors. Note that, in the case where the CPU 1700 includes a plurality of CPU cores, the various kinds of processing may be performed by the plurality of CPU cores in cooperation with one another, or may be performed by one CPU core among them. In the case where each CPU core includes a plurality of processors, the various kinds of processing may be performed by a plurality of processors in cooperation with one another, or may be performed by one processor among them.

The memory 1710 is a random access memory (RAM) such as, for example, a dynamic RAM (DRAM). The storage 1720 is, for example, a nonvolatile memory such as a read only memory (ROM) or a flash memory, or a magnetic disk device such as a solid stage drive (SSD) or a hard disk drive (HDD). The communication interface 1730 is, for example, a network interface card (NIC). The input-output device 1740 is, for example, a keyboard, a mouse, a display, or the like.

The functional blocks illustrated in FIG. 5 are implemented by the authentication server device 220 including the basic configuration of hardware illustrated in FIG. 17. Additionally, processes as illustrated in FIG. 6, FIG. 8, FIG. 10, FIG. 11, FIG. 13, and FIG. 16 are performed.

According to the embodiment described above, the expiration date of authorization information having a term of validity used for an authorization process of the user is updated using a period decided based on the history of authorization processes, thereby being updated in accordance with a situation in which the authorization process for the user is requested. Therefore, authorization information registered in the database is maintained and deleted in accordance with the situation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method comprising:
receiving a request for processing, the processing having to be preceded by an authorization process for a source of the request, the authorization process being performed based on authorization information which a term of validity is set;
storing historical information indicative of a history of a request for the processing from the source; and
setting, by a processor, the term of validity of the authorization information based on the historical information.

2. The method according to claim 1, wherein the setting includes:
determining a frequency with which the process is requested based on the historical information, and
deciding the term of validity of the authorization information based on a relationship between the frequency and a reference.

3. The method according to claim 2, wherein
when the frequency is higher than the reference, the deciding decides a duration of validity of the authorization information in accordance with a second period longer than a first period used when the frequency is lower than the reference.

4. The method according to claim 2, wherein
when the frequency is lower than the reference, the deciding decides a duration of validity of the authorization information in accordance with a second period shorter than a first period used when the frequency is higher than the reference.

5. The method according to claim 1, wherein
the processing includes a plurality of kinds of processing,
the historical information includes identification information for identifying a kind of the processing, and
the setting sets, for each piece of the identification information, the term of validity of the authorization information, based on the historical information.

6. The method according to claim 1, further comprising:
receiving a new request for the processing from the source after the setting; and
prior to performing processing indicated by the new request for the processing, performing the authorization process for the source based on the authorization information having the set term of validity.

7. A system that manages a virtualization infrastructure in which a physical resource for processing information is virtualized, the system comprising:
a management device including a first processor and a first memory coupled to the first processor; and
an authentication device including a second processor and a second memory coupled to the second processor,
wherein the first processor of the management device is configured to:
upon accepting a request for processing related to a virtual system constructed in the virtualization infrastructure, from a user who uses the virtualization infrastructure, request, before performing the processing, the authentication device to perform an authorization process in which it is determined whether or not to authorize the user to use the virtualization infrastructure, and
with regard to the request for the authorization process, providing, to the authentication device, notification of processing identification information for identifying the processing from which the authorization process arises and user identification information for identifying the user,
the second processor of the authentication device is configured to:
upon accepting a request for the authorization process from the management device, perform the authorization process, based on authorization information having a term of validity for determining whether or not to authorize the user to use the virtualization infrastructure,
store a history of processing requested by the user by storing, in association with each other, the processing identification information and the user identification information provided,
estimate, based on the history, a time period taken until, when specific processing is requested by the user, an authorization process arising from subsequent processing following the specific processing is requested, and
update a term of validity of the authorization information having the term of validity based on the time period when the user is authorized in the authorization process arising from the specific processing.

8. The system according to claim 7, wherein the second processor of the authentication device is configured to:
extract, from the history, a plurality of records for the authorization process that has arisen from the specific processing,
for each of the plurality of records, acquire a time period elapsed until the authorization process arising from subsequent processing following the specific processing is requested,
calculate an average time period of a plurality of the elapsed time periods for the plurality of records, and
estimate the time period based on the average time period.

9. The system according to claim 7, wherein the second processor of the authentication device is configured to:
set the term of validity of the authorization information having a term of validity to a first time period when the estimated time period is longer than a specific reference, and
set the term of validity of the authorization information having a term of validity to a second time period longer than the first time period when the estimated time period is less than or equal to the specific reference.

10. The system according to claim 7, wherein the second processor of the authentication device is configured to:
accept a request for an authentication process based on the user identification information and a password associated with the user identification information,
perform the requested authentication process,
generate the authorization information having a term of validity upon success of the authentication process, and
issue the authorization information having the term of validity to the user.

11. The system according to claim 10, wherein the second processor of the authentication device is configured to:
register the generated authorization information having a term of validity in a database, and
delete the authorization information having the term of validity from the database upon completion of the term of validity of the authorization information having a term of validity within the database.

12. The system according to claim 7, wherein
the first processor of the management device is configured to:
in accordance with a kind of a virtual resource of the virtualization infrastructure, execute a plurality of components for performing the processing related to a virtual system constructed in the virtualization infrastructure,
wherein each of the plurality of components requests the authentication device to perform the authentication process before performing the processing.

13. The system according to claim 7, further comprising:
an acceptance device including a third processor and a third memory coupled to the third processor,
wherein the third processor of the acceptance device is configured to:
upon accepting a request for the process from the user, request the management device to perform the process, by executing a specific program in accordance with a kind of the process accepted, and
notify the management device of program identification information for identifying the specific program, as the process identification information.

14. The system according to claim 7, wherein
the processing from which the authorization process arises is processing involving changing usage details of a virtual resource in the virtualization infrastructure.

15. An authentication device comprising:
a memory; and
a processor coupled to the memory and configured to:
upon accepting a request for an authorization process in which it is determined whether or not to authorize a user to use a virtualization infrastructure, perform the authorization process, based on authorization information having a term of validity for determining whether or not to authorize the user to use the virtualization infrastructure,
store a history of processing requested by the user by storing, in association with each other, processing identification information for identifying processing from which the authorization process arises and user identification information provided with regard to the request for the authorization process,
estimate, based on the history, a time period taken until, when specific processing is requested by the user, an authorization process arising from subsequent processing following the specific processing is requested, and
update a term of validity of the authorization information having the term of validity based on the time period when the user is authorized in the authorization process arising from the specific processing.
